(19) United States
(12) Patent Application Publication
(10) Pub. No.: US 2024/0053508 A1
(43) Pub. Date: Feb. 15, 2024

(54) CONTINUOUS GROUNDWATER MONITORING USING MACHINE LEARNING

(71) Applicant: Akhila Ram, Lexington, MA (US)

(72) Inventor: Akhila Ram, Lexington, MA (US)

(21) Appl. No.: 17/886,812

(22) Filed: Aug. 12, 2022

(51) Int. Cl. G01W 1/10; G01W 1/14; G01W 1/02; G06V 20/13; G06V 20/10; G06N 5/00

(52) U.S. Cl. CPC G01W 1/10; G01W 1/14; G01W 1/02; G06V 20/13; G06V 20/182; G06N 5/003

(57) ABSTRACT

Techniques are described for predicting groundwater for a locale, which is a subregion of a geographic region for which measurements of water storage are available at a coarse level. In a method, in response to receiving an input locale, a prediction of groundwater level for the input locale is provided. The prediction of groundwater level at the input locale is computed using a machine learning model. The machine learning model uses a plurality of parameters, which are weighted during a training phase of the machine learning model, and water storage measurements for a geographic region that encompasses the locale, the geographic region being larger than the locale, and wherein a resolution of the water storage measurements is downscaled. The prediction of groundwater level is outputted for the input locale.

### INTRODUCTION

The subject disclosure relates to machine learning, and in particular to groundwater monitoring using machine learning.

Groundwater management is crucial for maintaining the world's water resources. Fifty percent of the world relies on groundwater for drinking and forty-three percent relies on groundwater for irrigation. Factors such as over-pumping, climate change, and poor management are placing increasing stress on groundwater resources. Policy decisions to preserve this precious resource require timely up-to-date information on the current status of groundwater. Obtaining some or all of these goals opens the door for possible innovative design of improved monitoring of ground water resources.

### SUMMARY

Techniques for predicting groundwater for a locale, which is a subregion of a geographic region for which measurements of water storage are available at a coarse level, include a computer-implemented method. In the method, in response to receiving an input locale, a prediction of groundwater level for the input locale is provided. The prediction of groundwater level at the input locale is computed using a machine learning model. The machine learning model uses a plurality of parameters, which are weighted during a training phase of the machine learning model, and water storage measurements for a geographic region that encompasses the locale, the geographic region being larger than the locale, and wherein a resolution of the water storage measurements is downscaled. The prediction of groundwater level is outputted for the input locale.

According to one or more embodiments, a system includes a first groundwater measurement system that provides satellite-based measurements of a country. The system further includes a second groundwater measurement system that provides land-based measurements of groundwater of the country. The system further includes a machine learning system that computes a prediction of groundwater for a locale by downscaling the satellite-based measurements, and wherein the machine learning system uses a trained regression random forest model, validated by the land-based measurements. The system further includes a user interface system that receives an input locale and outputs a predicted groundwater level at the input locale by using the machine learning system.

According to one or more embodiments, another computer-implemented method includes displaying a geographic map of a country via a user interface, the geographic map depicting groundwater level measurements from a satellite-based system, the groundwater level measurements captured at a first resolution. The method further includes receiving, via the user interface, an identification of a locale on the geographic map, the locale being smaller than a unit of the first resolution. The method further includes predicting a groundwater level for the locale by using the a machine learning model. The method further includes depicting the groundwater level predicted for the locale on the geographic map by representing the locale on the geographic map using a visual effect corresponding to the groundwater level predicted.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a system for continuous groundwater monitoring and predicting at a local level according to one or more embodiments of the present invention;

FIG. 2 depicts an example machine learning model according to one or more embodiments;

FIG. 3 depicts a map of a geographic region (USA) that displays total water storage measurements obtained from a satellite-based measurement system according to one or more embodiments;

FIG. 4 depicts the map of the same geographic region (USA) that displays groundwater level anomaly predictions based on a machine learning model according to one or more embodiments;

FIG. 5 depicts a flowchart of a method for predicting groundwater level anomalies according to one or more embodiments; and

FIG. 6 depicts an example scenario of a user interface according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein address technical challenges with monitoring groundwater resources and providing predictions of available groundwater at particular timepoints in the future. Alternatively, or in addition, the technical solutions described herein address technical challenges with machine learning models that are used for monitoring and estimating groundwater availability. Accordingly, technical solutions described herein are rooted in computing technology. Further, technical solutions described herein provide practical applications of and improvements to using machine learning models to improve groundwater monitoring and estimating. Additionally, technical solutions described herein provide improvements to architectures of machine learning models used for groundwater monitoring and estimating.

The conventional way to overcome such technical challenges is to build dedicated monitoring wells for monitoring groundwater information. Building such wells is expensive. Building high-quality monitoring wells can cost between USD 100,000 to USD 200,000 each. Thus, such wells are rare. Other approaches of using remote sensing, with its ability to extract detailed global information in real-time, is a low-cost alternative that has shown promise. However, such information is not readily available yet, and brings its own set of technical challenges.

The technical solutions described herein facilitate continuous groundwater monitoring and prediction using measurements from satellite data. The leading satellites for measuring global trends in water storage include Gravity Recovery and Climate Experiment (GRACE) and, Gravity Recovery and Climate Experiment Follow-On (GRACE-FO). However, GRACE and GRACE-FO have a coarse spatial resolution of 200,000 km2, making them sensitive only to large-scale mass changes. Therefore, the measurements from these satellites fail to provide groundwater indicators at a local scale, which is the level at which water management information is needed for making policy decisions at a local scale. Here, “local scale” includes at a city, county, or a smaller geographical region that relies on local, limited set of groundwater resources. In order to prevent groundwater stress, management agencies need to know groundwater trends so they can be proactive in their policies. If groundwater stress is identified, policies like MAR (managed aquifer recharge) can be implemented to increase groundwater levels. MAR policies range from implementing infiltration ponds to stream bed channel modifications. However, MAR can only be implemented when there is sufficient information on the current state of groundwater locally.

State of the art techniques use satellite measurements for groundwater predictions in two ways. Physics-based modeling has been used for large-scale prediction models. Dynamic models, when forced with meteorological data, can provide approximate representations of interactions between climatic variables and their effects on groundwater. However, physical models pose certain drawbacks as they are computationally intensive, and may not account for anthropogenic influence. Examples of predictive models that use satellite measurements for groundwater monitoring and to simulate groundwater storage include WaterGAP Global Hydrology Model (WGHM) and Catchment Land Surface Model (CLSM). These existing models can simulate changes in groundwater levels, although, the predictions are made at a global scale (i.e., across entire earth, or a large area, such as a continent, or a country (i.e., prediction of groundwater for an area that is larger than a predetermined threshold)). The existing models fail to consider changes in groundwater levels due to irrigation. However, over-pumping of groundwater due to irrigation is one of the largest sources of variability in groundwater levels. It is approximated that over 20% of the world's aquifers are being overexploited due to pumping.

Several machine learning techniques have been attempted for monitoring groundwater. Several studies have downscaled the resolution of satellite by training machine learning models to predict groundwater levels given satellite data and other meteorological inputs. These models have shown robust performance, predicting groundwater levels at a high spatial resolution of ˜16 km2. These studies typically focus on a small location, such as a basin. Thus, acquiring predictions for multiple basins would require retraining the model with data from each basin. This method does not generalize to basins where there is limited monitoring data. Further, studies have also used satellite data along with unevenly spaced time series data to predict changes in groundwater levels. However, such methods rely on the existence of previous groundwater measurements at a given location, which can sometimes be unfeasible.

Technical solutions described herein address the challenges of groundwater monitoring and prediction, and particularly, using machine learning models for groundwater monitoring and prediction for specific areas (i.e., geographic areas smaller than a predetermined threshold, or geographic areas including only a limited number of groundwater resources). Other limitations can be imposed to limit the size of the geographic area for which groundwater monitoring is being performed in other embodiments. Technical solutions described herein improve generalizability in regions with limited data by providing finer resolution signals from coarse satellite data inputs.

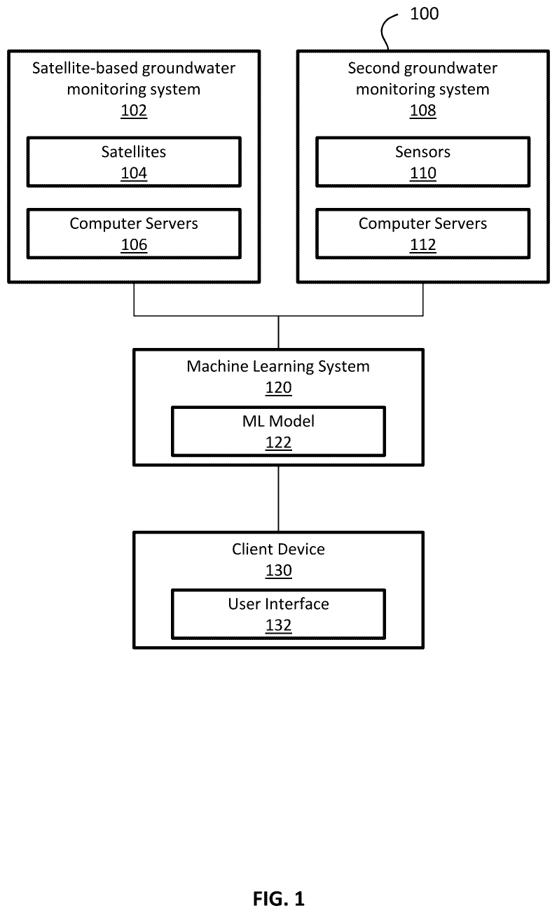

FIG. 1 depicts a system for continuous groundwater monitoring and predicting at a local level according to one or more embodiments of the present invention.

The system 100 includes a first measurement system 102 that provides satellite data measurements that are related to groundwater. The groundwater level measurements can be obtained for one or more countries. The first measurement system 102 includes, among other components, one or more satellites 104 and one or more computer servers 106. The computer servers 106 can be accessed to retrieve the satellite data. Examples of satellite-based systems for measuring global trends in water storage are Gravity Recovery and Climate Experiment (GRACE) and its successor, Gravity Recovery and Climate Experiment Follow-On (GRACE-FO). However, such satellite-based groundwater measurement systems have a coarse spatial resolution of ˜200,000 km², making them sensitive only to large-scale mass changes. They fail to provide groundwater indicators at a local scale, which is the level at which water management. Here, “local” can include spatial resolution in the range of 10 km²-1000 km², which is orders of magnitude smaller than the resolution provided by the satellite-based groundwater measurement systems 102. It should be noted that the satellite data represents aspects of the natural world that are correlated with groundwater levels, and as such, the satellite data may not be actual representation of a quantity of groundwater.

The system 100 further includes a second groundwater measurement system 108 that provides land-based measurements of groundwater. The groundwater level measurements can be obtained for one or more countries. The first groundwater measurement system 108 includes, among other components, one or more sensors (e.g., wells, monitoring stations, etc.) 110 and one or more computer servers 112. The computer servers 112 can be accessed to retrieve groundwater measurements obtained by using the sensors 110. For example, land-based systems for measuring groundwater include one or more wells for which data can be accessed via online data providers, such as, government agencies like USGS. However, such land-based groundwater measurement systems have sparce data, and hence, fail to provide continuous groundwater indicators at a local scale. In some embodiments, the second measurement system 108 is also a satellite-based system (e.g., GLDAS), distinct from the first measurement system 102.

The system 100 further includes a machine learning system 120 that computes a prediction of groundwater for a locale. Here, a “locale” refers to a geographic region in the range of 10 km²-1000 km², at which water management policies can be implemented. The “locale” can be a village, a town, a city, a county, a state, a water basin, a zipcode, or any other such smaller geographic area at which groundwater management policies can be made and implemented. The machine learning system 120 includes a machine learning (ML) model 122. The ML model 122 can be based on any type of ML model architecture, such as an artificial neural network, decision tree, support-vector machine, regression analysis model, Bayesian network, etc.

The ML model 122 can be trained using satellite data obtained from the first measurement system 102 and validated using historic groundwater measurements obtained from the second measurement system 108, or a combination thereof. Additionally, the training can use ground truth data that indicates the actual groundwater levels at one or more locales at particular timepoints. The ML model 122 can be trained using supervised learning, unsupervised learning, semi-supervised learning, reinforcement learning, or any other technique or a combination thereof.

As noted herein, the system 100 addresses technical challenges with existing systems to predict groundwater levels/measurements for locales. In other words, the system 100, using the machine learning system 120, facilitates predicting groundwater levels for a larger region (e.g., entire United States of America) at a high resolution, so that groundwater level at a particular location, such as, which can be specified by a combination of a latitude and longitudinal values, can be predicted. Accordingly, embodiments described herein technical challenges such as low spatial resolution of groundwater estimates. In addition, embodiments described herein facilitate predicting groundwater levels at such a higher resolution (i.e., locales), without requiring model retraining for each water basin. Additionally, embodiments described herein address the technical challenge of modeling pumping due to irrigation into the groundwater level predictions.

In one or more embodiments, the ML model 122 is a random forest model that downscales the satellite data, e.g., from the first measurement system 102. Examples described herein use the United States of America (USA) and one or more locales within that country. However, it is understood that technical solutions described herein are applicable to any other geographies, and not limited to any particular country and/or locale. USA provides geographical diversity. The topography includes coastal plains, mountains, temperate and subtropical moist and wet forests, and grasslands, making it a representative area to train the ML model 122 on a variety of geographical regions.

Embodiments described herein provide a single ML model 122 that can provide real-time predictions of groundwater levels for an entire geographic region (e.g., country) on a per locale level. Such groundwater level predictions assist for low-resource regions that do not have the monitoring data to train region-specific models. Further, the groundwater predictions facilitate determining and implementing groundwater conservation efforts.

The system 100 further includes a client device 130. The client device 130 facilitates interaction with the machine learning system 120 via a user interface 132. For example, the client device 130, via the user interface 132, receives an input locale and, in response, outputs a groundwater level at the input locale as predicted by the machine learning system. The client device 130 can receive and/or output several other types of information, data, visualization, graphics, animations, etc., as described herein.

It should be noted that the one or more components of the system 100 are shown as separate blocks in FIG. 1 as an illustration. In one or more embodiments, the components can be organized in a different manner. For example, the machine learning system 120 and the client device 130 can be part of the same device. Any other combination/separation of the components is possible. The components, such as the machine learning system 120, and the client device 130 can be a computer server, a desktop computer, a laptop computer, a phone, or any other computing device. The components of the system 100 can communicate with each other in a wired and/or wireless manner. The communication can facilitate transfer of data and/or commands. The communication can use one or more known protocols, or any future developed protocols. Further, it is understood that the system 100 can include several other components, such as communication ports, cables, memory devices, processing units, etc., which are not explicitly shown. Also, the computing devices used and described herein can perform one or more operations herein in a sequential or parallel manner. Further yet, the processing can be performed in a local, remote, or distributed manner in some embodiments. Also, in some embodiments, the one or more computing devices described herein can use cloud computing technology, without limiting aspects of the technical solutions described herein.

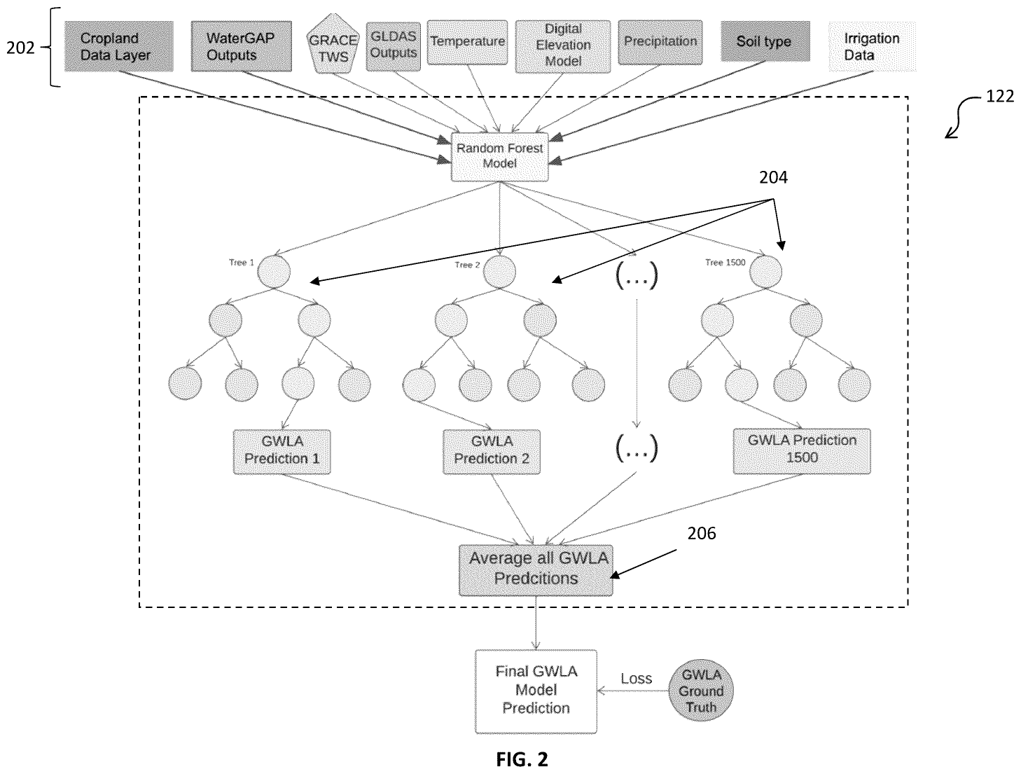

FIG. 2 depicts an example machine learning model according to one or more embodiments. The ML model 122 depicted is a regression random forest model. However, in other embodiments, other types of architecture can be used to build the ML model 122. Random forest model is an ensemble of learning and decision-tree (204) based ML algorithm. The ML model 122 includes as many individual decision trees 204 as the number of estimators. The number of estimators can be varied, and is typically predetermined. For example, the number of estimators can be 1500, 2000, 2500, 3000, etc. Each individual decision tree 204 works independently to provide a respective output prediction. The predictions from the several decision trees 204 are combined (206), for example, by computing a mean. The result of the combining is the final output of the ML model 122.

During training, the output of the ML model 122 is compared with ground truth values in the training data. Based on a difference (loss) between the prediction and the ground truth one or more parameters (weights) of the ML model 122 are adjusted. Such a loop for the adjustment and comparison is iterated until the difference between the prediction and the ground truth satisfies a predetermined threshold.

Further, the ML model 122 is based on deriving groundwater measurements from the satellite-based and land-based measurement systems (102, 108). In some aspects, the data from the satellite-based system (102) is has to be pre-processed to create monthly terrestrial water storage (TWS) anomalies. The TWS anomalies can include soil, moisture, snow, surface water, and groundwater anomalies. Disaggregation of TWS is performed by calculating differences in the TWS anomalies and changes in water storage as calculated by the various satellite systems. To obtain the change in groundwater from the TWS, measurements from the satellite data, such as surface water (SW), snow-water equivalent (SWE), and soil moisture data (SM), etc., are subtracted from the TWS. In some embodiments, one or more measurements are obtained from the second measurement system 108. Below equation provides an example of groundwater level measurement based on the TWS from the satellite-based measurements and land-based measurements:

ΔGWL=ΔTWS−(ΔSM+ΔSWE+ΔSW)

Here, the values TWS (from 102) and SM, SWE, SW (from 102) captured at substantially the same timepoint/duration (e.g., end of a month, end of a week, etc.) are used to compute the GWL for that timepoint/duration.

The ML model 122 is trained on various satellite data for entire geographic region covered by the measurement systems (102), for example, entirety of USA. The ML model is validated on historic data of GWL data (108). The trained ML model 122 outputs a predicted GWL for a particular locale at a present timepoint based on data from the first measurement system 102. The ML model 122 uses several predictor features 202 to predict the GWL. The predictor features 202 can include but are not limited to temperature, precipitation, digital elevation, soil type, irrigation data, cropland data, WaterGAP outputs, GLDAS outputs. The respective value for the predictor features 202 can be obtained from the first and/or second measurement systems 102, 108. Alternatively, or in addition, values for the predictor features 202 can be obtained from other sources, such as weather service data providers, land survey data providers, etc., in an electronic/digital manner. The values can be obtained from such service providers via one or more computer servers (not shown) of the service providers, for example, using corresponding application programming interface(s).

In some aspects, precipitation data is obtained from NASA Global Precipitation Measurement (GPM), through the NASA GES DISC. The GPM (IMERG) product provides monthly global precipitation from 2000 to 2021 at a spatial resolution of 0.1°×0.1°.

In some aspects, land surface temperature data is obtained from the MERRA-2 product through NASA GES DISC. MERRA-2 provides monthly global temperatures from 1980 to 2021, at a spatial resolution of 0.5°×0.625°.

In some aspects, outputs from the GLDAS NOAH 2.1 Land surface model are used, namely, Wind Speed (WS), Evapotranspiration (ET), Root zone soil moisture (RZSM), Baseflow groundwater runoff (BFGR), Plant canopy surface water (PCSW), Snow water equivalent (SWE), Storm surface runoff (SSR), Soil moisture (SM), at a spatial resolution of 0.25°×0.25°. GLDAS simulates hydrological variables by integrating satellite and ground-based observations into land models. Data is available globally (90.0° N to 60.0° S), from 2000 to 2021.

In some aspects, elevation data is obtained from the GLDAS elevation field. The data is averaged from the GTOPO30 Global 30 Arc Second (˜1 km) Elevation Dataset to a resolution of 0.25°×0.25°. In some aspects, digital elevation model is obtained from USGS 3DEP, through Google Earth™ Engine.

In some aspects, cropland data layer (CDL) is obtained from USDA National Agricultural Statistics Service. Data resolution is 30 meters. Soil type data is obtained from the US Lithology dataset, for example, through the Google Earth™ Engine. Data resolution is 90 meters for such data. Irrigation data is obtained from MIrAD-US with a resolution of 1 km. Irrigation data provides information about irrigated croplands.

WaterGAP is a global hydrology model that calculates the changes in different water-related variables, including groundwater. The model outputs are at a resolution of 0.5°×0.5°. The WaterGAP model provides data, such as net abstraction from groundwater, potential total consumptive water use from groundwater, potential total water withdrawals from groundwater, potential irrigation consumptive water use, and potential irrigation water withdrawals.

Prior to training the ML model 122, land-based groundwater measurements are preprocessed to reflect the groundwater level anomaly (GWLA). Data is processed by subtracting the long term mean of the site from the depth to water level below the surface. The long term mean is calculated by averaging measurements over a period of time, e.g., from 2004-2009. Several million points (1.4 million) are obtained in this manner, which can be used to train the ML model 122. For example, the obtained points are split, e.g., 80-to-20, to train and test the ML model 122.

The random forest model (of FIG. 2) is able to predict GWLA with such training with an extremely high level of accuracy (R=0.98). accordingly, the ML model is able to quantify the complex relationships between the input hydrological predictor features 202 and GWLA. Experimental results have shown high Spearman Rho correlation (0.95) and an adequate RMSE (2.2 ft) to use the ML model 122 that is trained in this manner to generate predictions of GWLA for a locale.

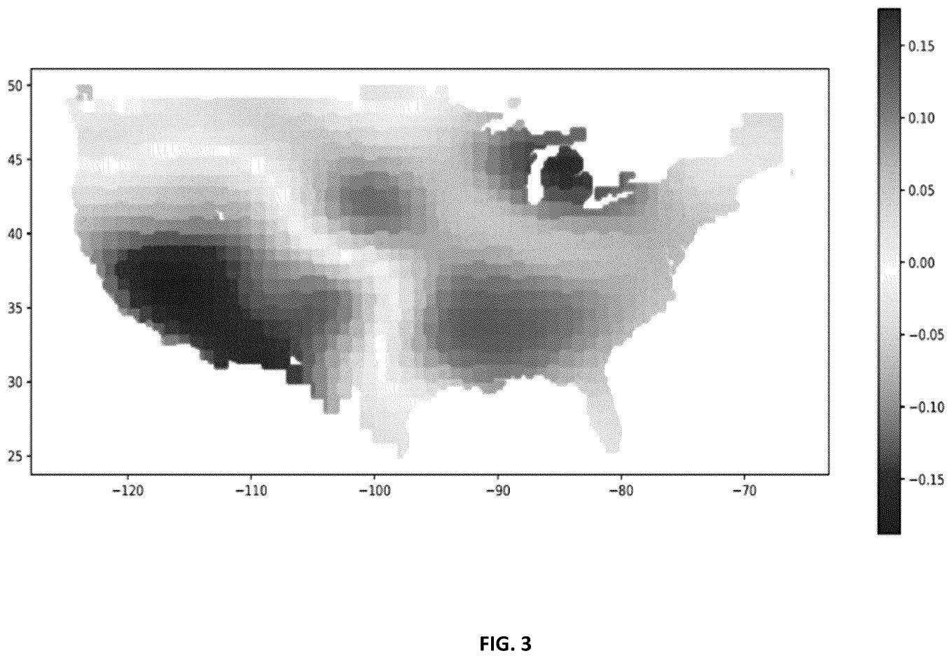

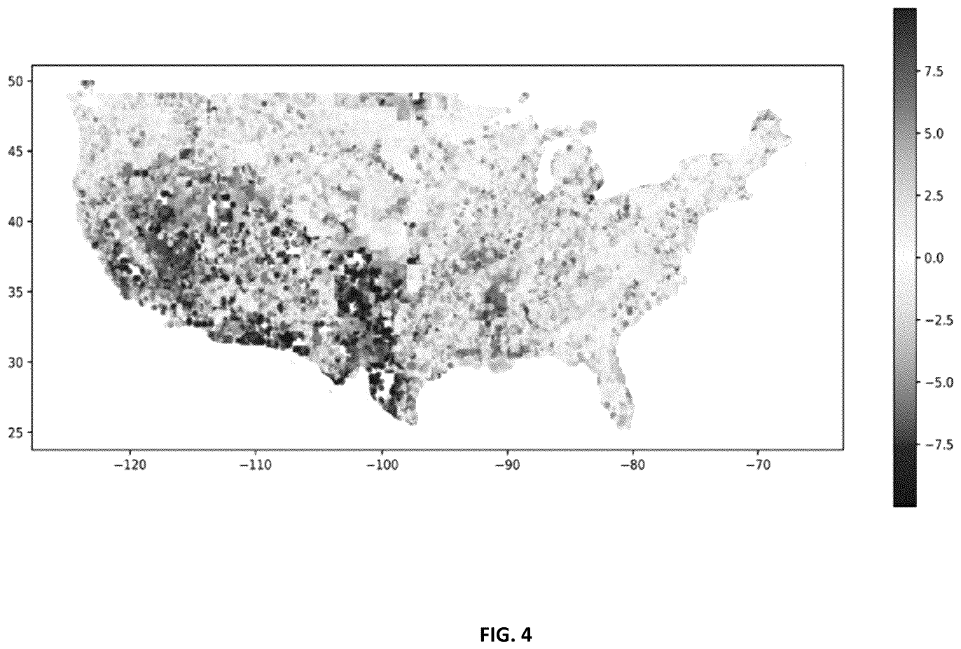

FIG. 3 depicts a map of a geographic region (USA) that displays total water storage measurements obtained from a satellite-based measurement system, in this case the GRACE system. FIG. 4 depicts the map of the same geographic region (USA) that displays GWLA predictions based on the ML model 122. The two maps, FIG. 3, and FIG. 4 are for the same month (August 2021), i.e., same timepoint/duration. The ML model's 122 downscaling of the TWS data is visible in the two figures, with the high resolution predictions of changes in groundwater levels clearly presented in FIG. 4. Compared to FIG. 3, which can only predict general changes in large regions, the ML model 122 is able to specifically pinpoint latitudes and longitudes of extreme abstraction and recharge. The ML model's 122 degree of heterogeneity compared to the TWS data (FIG. 3), indicates that the ML model 122 can provide more detailed predictions at locale level. overall, the ML model is accurately able to predict extreme groundwater depletion, for example, in southeastern USA.

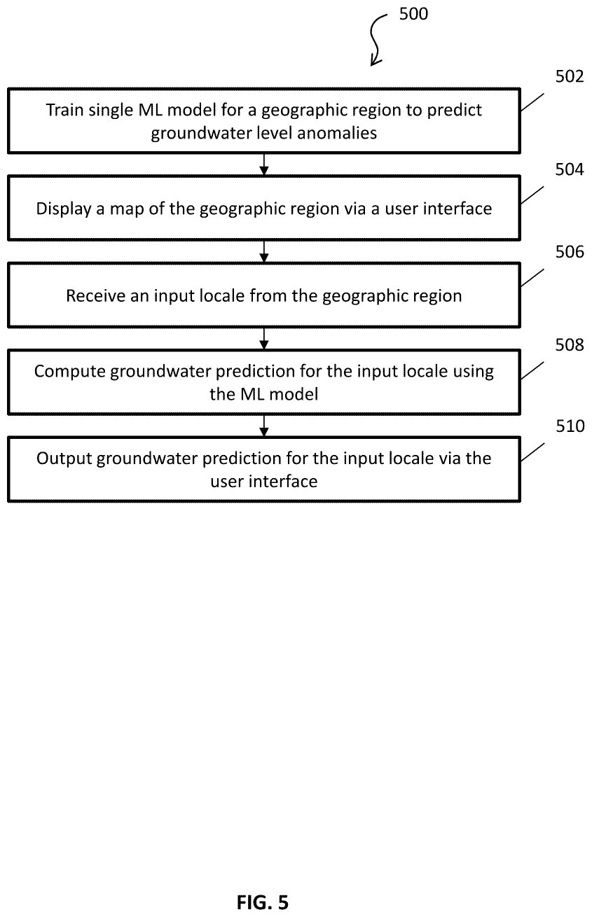

FIG. 5 depicts a flowchart of a method for predicting groundwater level anomalies according to one or more embodiments. The method 500 includes training a single ML model 122 to predict groundwater level anomalies for a geographic region, at block 502. For example, the ML model 122 is trained to predict GWLA for the geographic region of USA in the example scenario described herein. The training is performed to derive a relationship between the GWLA and several hydrological predictor features 202. In one or more embodiments, the ML model 122 is a random forest model. The ML model 122 is trained prior to actual use (i.e., inference phase) based on measurements obtained from one or more sources, e.g., first measurement system 102 and second measurement system 108. In some embodiments, training the ML model 122 includes disaggregation of the data as described herein. The disaggregated data is used to train the ML model 122.

At block 504, a map of the geographic region for which the ML model 122 is trained is displayed via the user interface 132.

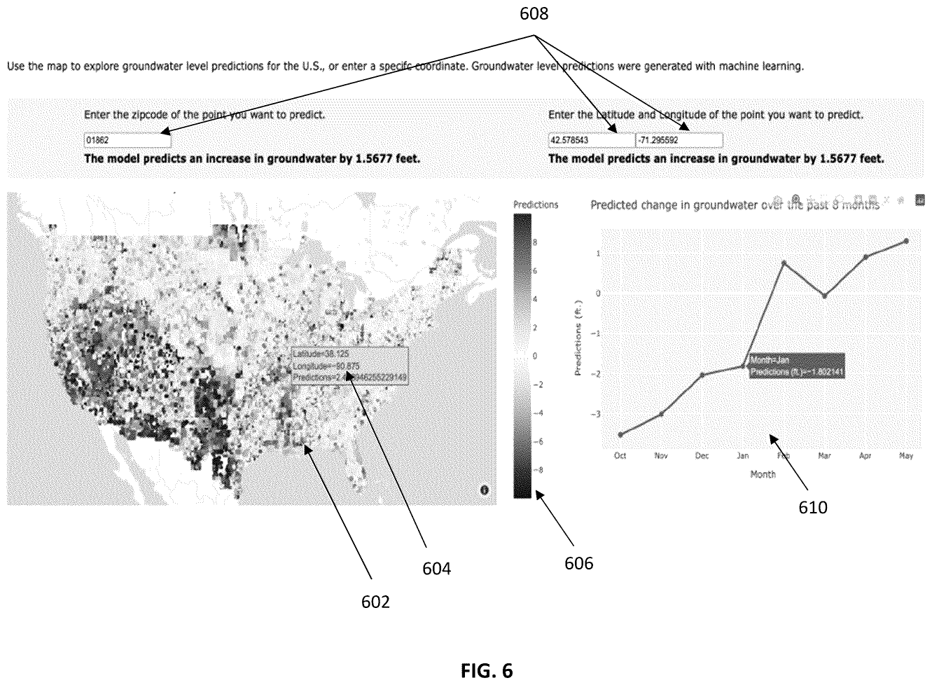

FIG. 6 depicts an example scenario of the user interface according to one or more embodiments. It is understood that elements depicted in FIG. 6 can be positioned differently in other embodiments. A map 602 of the geographic region can include GWLA predictions of one or more locales within the map 602. The GWLA may be depicted using a visual attribute, such as color, size, shape, image, icon, border, transparency, pattern, or any other such visual attribute or a combination thereof. In some embodiments, an index 606 is provided that indicates an interpretation of the visual attributes in terms of the GWLA.

In some embodiments, the map 602 depicts TWS measurements obtained from the satellite-based measurement system 102. The map 602, thus, depicts the groundwater levels at a coarse level, i.e., a first resolution.

In one or more embodiments, the map 602 is interactive. For example, a user can scroll, zoom, pan, etc. the map 602. Further, in some embodiments, the user may select a locale in the map 602 by clicking, touching, or using other types of user input. In some embodiments, the user may select a locale 604 by providing an identifier of the locale 604 via an input box 608. For example, the input box 608 can be used to receive a combination of latitude and longitude of the desired locale 604. Alternatively, the user can provide a zipcode associated with the locale 604 via the input box 608. Other types of identifiers can also be used in some embodiments, such as name, state, cross-street, etc.

In the case that the map 602 is depicted showing the TWS measurements at the coarse level, the input locale 604 can be smaller than a unit of the first resolution used to depict the coarse level.

Referring to the flowchart, at block 506, the method 500 includes receiving an input locale 604. The input locale is a subregion of the geographic region depicted in the map 602, and for which the single ML model 122 is created and trained. The locale 604 is selected using the user interface 132 using one or more techniques described herein.

At block 508, in response to receiving the input locale 604, a prediction of GWLA for the locale 604 is computed by the ML model 122.

The ML model 122 uses several predictors 202, which are weighted during the training phase of the ML model 122. The ML model 122 further uses the water storage measurements for the geographic region that encompasses the locale 604. The resolution of the water storage measurements is downscaled. The water storage measurements are obtained from the satellite-based measurement system 102, in one or more embodiments. Alternatively, or in addition, the water storage measurements are computed for the geographic region based on the satellite-based measurements and land-based data from land-based measurement system 108.

In some aspects, the ML model 122 is a regression random forest model. The ML model 122 uses a plurality of parameters/predictors 202, such as precipitation, temperature, wind speed, evapotranspiration, soil moisture, water runoff, digital elevation, cropland data, soil type, and irrigation. The predictors are received from multiple sources, such as the satellite-based measurement system 102 and the second measurement system 108.

In some embodiments, predicting the groundwater level for the locale 604 includes downscaling the groundwater data from the first measurement system 102 and/or the second measurement system 108.

At block 510, the prediction of groundwater level for the input locale 604 is output via the user interface. For example, the groundwater level predicted for the locale 604 is depicted on the geographic map 602 by representing the locale 604 on the geographic map 602 using a visual effect corresponding to the groundwater level predicted.

In some embodiments, the output includes a graph 610. The graph 610 includes a predetermined number of groundwater level predictions for the locale 604. In some embodiments, the output further includes a trend indicative of a change in the groundwater level based on the groundwater level predicted and past groundwater level measurements of the locale 604.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A computer-implemented method for predicting groundwater for a locale, the computer-implemented method comprising:
in response to receiving an input locale, providing a prediction of groundwater level for the input locale, wherein providing the prediction comprises:
computing the prediction of groundwater level at the input locale using a machine learning model, wherein the machine learning model uses:
a plurality of parameters, which are weighted during a training phase of the machine learning model, and
water storage measurements for a geographic region that encompasses the locale, the geographic region being larger than the locale, and wherein a resolution of the water storage measurements is downscaled; and
outputting the prediction of groundwater level for the input locale.

2. The computer-implemented method of claim 1, wherein the water storage measurements are satellite measurements.

3. The computer-implemented method of claim 1, wherein the water storage measurements are computed for the geographic region based on satellite measurements.

4. The computer-implemented method of claim 1, wherein the machine learning model is a regression random forest model.

5. The computer-implemented method of claim 4, wherein the plurality of parameters comprises precipitation, temperature, wind speed, evapotranspiration, soil moisture, water runoff, digital elevation, cropland data, soil type, and irrigation.

6. The computer-implemented method of claim 1, wherein the plurality of parameters is received from multiple sources.

7. The computer-implemented method of claim 1, wherein the plurality of parameters comprises precipitation, temperature, wind speed, evapotranspiration, soil moisture, water runoff, digital elevation, cropland data, soil type, and irrigation.

8. A system comprising:
a first groundwater measurement system that provides satellite-based measurements of a country;
a second groundwater measurement system that provides land-based measurements of groundwater of the country;
a machine learning system that computes a prediction of groundwater for a locale by downscaling the satellite-based measurements, and wherein the machine learning system uses a trained regression random forest model, validated by the land-based measurements; and
a user interface system that receives an input locale and outputs a predicted groundwater level at the input locale by using the machine learning system.

9. The system of claim 8, wherein the satellite-based measurements are obtained from Gravity Recovery and Climate Experiment (GRACE) satellites.

10. The system of claim 8, wherein the land-based measurements are obtained from groundwater wells across a region.

11. The system of claim 8, wherein the machine learning system computes the prediction of groundwater for the locale by disaggregation of the satellite-based measurements by calculating differences in anomalies in one or more satellite-based measurements.

12. The system of claim 8, wherein the user interface system outputs the predicted groundwater level by representing the input locale in a geographic map using a visual attribute corresponding to the predicted groundwater level.

13. The system of claim 8, wherein the machine learning system uses a plurality of parameters comprising precipitation, temperature, wind speed, evapotranspiration, soil moisture, water runoff, digital elevation, cropland data, soil type, and irrigation.

14. The system of claim 8, wherein the locale is one from a group comprising a zip code, a state, a county, and a combination of latitude and longitude.

15. A computer-implemented method comprising:
displaying a geographic map of a country via a user interface, the geographic map depicting groundwater level measurements from a satellite-based system, the groundwater level measurements captured at a first resolution;
receiving, via the user interface, an identification of a locale on the geographic map, the locale being smaller than a unit of the first resolution;
predicting a groundwater level for the locale by using a machine learning model; and
depicting the groundwater level predicted for the locale on the geographic map by representing the locale on the geographic map using a visual effect corresponding to the groundwater level predicted.

16. The computer-implemented method of claim 15, wherein the identification of the locale is a combination of a latitude and longitude.

17. The computer-implemented method of claim 15, wherein the identification of the locale is one from a group comprising a county, a town, a city, a state, a zip-code.

18. The computer-implemented method of claim 15, wherein predicting the groundwater level for the locale uses a regression random forest model.

19. The computer-implemented method of claim 15, further comprising:
outputting a graph of predetermined number of groundwater level predictions for the locale.

20. The computer-implemented method of claim 15, further comprising, outputting a trend indicative of a change in the groundwater level based on the groundwater level predicted and past groundwater level measurements of the locale.
